(19) United States
(12) Patent Application Publication
(10) Pub. No.: US 2012/0013239 A1
(43) Pub. Date: Jan. 19, 2012

(54) MULTI-SPARK SPARK PLUGS AND METHODS OF MANUFACTURE

(76) Inventor: Terumasa Fujiwara, Kobe (JP)

(21) Appl. No.: 12/835,352

(22) Filed: Jul. 13, 2010

(51) Int. Cl. H01T 13/20; H01T 21/02

(52) U.S. Cl. 313/141; 445/7

(57) ABSTRACT

In various embodiments, a spark plug includes an electrically conductive body disposed around an insulator, a tip of the insulator protruding from the body, a generally radially disposed annular groove formed by the insulator tip, a center electrode disposed within the insulator, a tip of the center electrode protruding from the insulator tip, and an annular auxiliary electrode disposed within the annular groove, the auxiliary electrode having a center portion thicker than an edge portion thereof. A longitudinal length of the auxiliary electrode may be greater than a radial thickness of the auxiliary electrode.

### FIELD OF THE INVENTION

The technology disclosed herein relates generally to spark plugs, specifically spark plugs having auxiliary electrodes enabling multiple sparks per ignition cycle.

### BACKGROUND

Spark plugs (or sparking plugs) are utilized to generate the electric sparks that ignite the aerated fuel in the combustion chambers of many types of internal-combustion engines. The sparks are generated through the application of a large voltage between an axially located center electrode and a ground electrode, which is electrically insulated from the center electrode by an insulator (typically a ceramic material) surrounding the center electrode. Although many spark-plug designs have been developed and tested over the past century, modern spark plugs commonly utilize a ground electrode formed in the shape of a hook overhanging the center electrode, forming a spark gap therebetween across which current flows when the dielectric-breakdown voltage of the air/fuel mixture is exceeded.

Such spark plugs are relatively easy and inexpensive to manufacture, but they feature only a single spark gap, and thus produce only a single spark per ignition cycle. Hence, the spark-gap size is crucial to proper engine operation. If the spark gap is too small, the spark created therein may be too weak to ignite the air-fuel mixture; however, if the spark gap is too large, the spark plug may not properly “fire,” i.e., produce a spark, during each cycle. Spark plug manufacturers have designed some spark plugs with multiple overhanging ground electrodes capable of more reliably sparking during each ignition cycle, as the formation of alternative spark paths enhances the probability of proper fuel ignition during each cycle. However, these plugs are expensive and difficult to manufacture, and must be carefully handled prior to use, as improper spacing of even a single ground electrode will result in excessive wear to that electrode and impair the plug's capability to spark. And, even properly manufactured and handled plugs may exhibit uneven wear among the multiple ground electrodes, leading to degraded performance.

Spark plug manufacturers have experimented with designs for spark plugs incorporating additional electrodes between the center and ground electrodes, thus forming a segmented spark path therebetween. However, these additional electrodes typically are mechanically bonded to the spark plug insulator and/or have irregular shapes or cross-sections. Such electrodes tend to fail prematurely via cracking or delamination (due to, e.g., mismatch of thermal-expansion coefficients) or are complicated and expensive to manufacture.

Thus, there is a need for an improved spark plug design featuring multiple-spark capability that is inexpensive to manufacture, and that exhibits long life and reliable performance.

### SUMMARY

In accordance with various embodiments of the invention, cascading or multi-spark spark plugs, i.e., spark plugs forming multiple spark discharges per ignition cycle, utilize at least one auxiliary electrode disposed between the center electrode and the ground electrode. The auxiliary electrode(s) effectively redirect the conventional spark path into multiple smaller spark gaps across which sparks form during operation. Because multiple sparks are formed, efficient ignition of the air-fuel mixture (even lean mixtures) is more readily and reliably accomplished.

The auxiliary electrode(s) are typically fashioned within annular grooves formed in the insulator in order to enable spark production at any position around the circumference of the insulator (and the center electrode). The grooves are preferably at least substantially filled with the auxiliary-electrode material by spray deposition, and are thus more mechanically stable and reliable than if they were adhered or bonded to the insulator or otherwise formed as separate rings. Embodiments of the invention feature grooves (and therefore the resulting auxiliary electrodes) sized and shaped to facilitate void-free filling by spray deposition.

In an aspect, embodiments of the invention feature a spark plug including an electrically conductive body disposed around an insulator, a tip of the insulator protruding from the body. A generally radially disposed annular groove is formed by the insulator tip, and an annular auxiliary electrode is disposed within the annular groove. A center electrode is disposed within the insulator, and the tip of the center electrode protrudes from the insulator tip. A center portion of the auxiliary electrode is thicker than an edge portion thereof, and a longitudinal length of the auxiliary electrode is greater than (or equal to) a radial thickness of the auxiliary electrode.

Embodiments of the invention may include one or more of the following, in any of a variety of combinations. The auxiliary electrode may not protrude from the groove and/or may substantially fill the groove. The cross-sectional shape of the auxiliary electrode may be substantially semicircular or substantially triangular (and may have a substantially rounded rather than a sharply defined vertex). The exposed surfaces of the auxiliary electrode and the insulator tip may form a cylinder or truncated cone having a substantially contiguous contour. The auxiliary electrode may include or consist essentially of a nickel-based alloy, e.g., a NiAl alloy, a NiCr alloy, a NiCrFeNbTaMoTi alloy, a NiCrFeBoTaMoBTi alloy, and/or alloys or mixtures thereof. The melting point of the auxiliary electrode may be in a range between approximately 1400° C. and approximately 1500° C. The auxiliary electrode may be substantially seamless. The spark plug may include one or more additional annular grooves spaced apart from the annular groove and formed by the insulator tip, and an additional auxiliary electrode may be disposed within each additional annular groove.

In another aspect, embodiments of the invention feature a method of forming a spark plug. An insulator is provided, the insulator having an annular groove formed by a tip thereof. An auxiliary electrode material is spray deposited within the groove, thereby forming an annular auxiliary electrode disposed within the groove. A center electrode is disposed within the insulator such that the tip of the center electrode protrudes from the insulator tip. At least a portion of the insulator is disposed within an electrically conductive body.

Embodiments of the invention may include one or more of the following, in any of a variety of combinations. The auxiliary electrode material may be deposited by a thermal spray process. Prior to deposition, the auxiliary electrode material may be in powder or wire form, and the auxiliary electrode material may substantially or partially melt during deposition. The insulator may be rotated during deposition of the auxiliary electrode material. Neither the insulator tip nor the auxiliary electrode need be mechanically ground after deposition of the auxiliary electrode material; however, a grit polishing step may be performed to smooth exterior surfaces. The exposed surface of the auxiliary electrode and the exposed surface of the insulator may be substantially contiguous. The auxiliary electrode may include or consist essentially of a nickel-based alloy, e.g., a NiAl alloy, a NiCr alloy, a NiCrFeNbTaMoTi alloy, a NiCrFeBoTaMoBTi alloy, and/or alloys or mixtures thereof. The center portion of the auxiliary electrode may be thicker than the edge portion of the auxiliary electrode. The longitudinal length of the auxiliary electrode may be greater than (or equal to) the radial thickness of the auxiliary electrode. One or more additional annular grooves spaced apart from the annular groove may be formed by the tip of the insulator. The auxiliary electrode material may be spray deposited within the additional groove(s), thereby forming one or more annular auxiliary electrodes each disposed within an additional groove.

In yet another aspect, embodiments of the invention feature a spark plug including an electrically conductive body disposed around an insulator, a tip of the insulator protruding from the body. A center electrode is disposed within the insulator, and the tip of the center electrode protrudes from the insulator tip. An auxiliary electrode including or consisting essentially of a nickel-based alloy is disposed along the insulator tip and spaced apart from the center electrode tip and the body.

Embodiments of the invention may include one or more of the following features, in any of a variety of combinations. The nickel-based alloy may include or consist essentially of a NiAl alloy, a NiCr alloy, a NiCrFeNbTaMoTi alloy, a NiCrFeBoTaMoBTi alloy, and/or alloys or mixtures thereof. The auxiliary electrode may be substantially annular and/or disposed within and substantially filling an annular groove formed by the insulator tip. The center portion of the auxiliary electrode may be thicker than the edge portion of the auxiliary electrode. The longitudinal length of the auxiliary electrode may be greater than (or equal to) the radial thickness of the auxiliary electrode. One or more additional auxiliary electrodes may be disposed along the insulator tip and spaced apart from the center electrode tip and the auxiliary electrode. The auxiliary electrode(s) may include or consist essentially of the nickel-based alloy.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. As used herein, the term “substantially” means±10% and, in some embodiments, ±5%. The term “consists essentially of” means excluding other materials that contribute to function, unless otherwise defined herein. Nonetheless, such other materials may be present, collectively or individually, in trace amounts.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a side view of a spark plug in accordance with certain embodiments of the invention;

FIGS. 2A and 2B are an enlarged side view and an enlarged cross-section, respectively, of the insulator tip and auxiliary electrodes of the spark plug of FIG. 1;

FIGS. 3A and 3B are a side view and a cross-section, respectively, of an exemplary spark plug in accordance with an embodiment of the invention; and

FIGS. 4A and 4B are a side view and a cross-section, respectively, of an exemplary spark plug in accordance with another embodiment of the invention.

### DETAILED DESCRIPTION

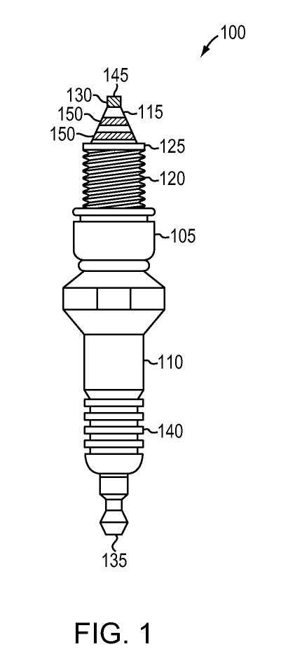

FIG. 1 depicts a spark plug 100 in accordance with certain embodiments of the present invention. The spark plug 100 includes an electrically conductive body 105 disposed around an insulator 110, a tip 115 of which protrudes from the body 105. The body 105 typically includes or consists essentially of a metal or metal alloy (e.g., steel), and couples to and seals a combustion chamber of an internal combustion engine, via engagement of threads 120 to complementary threads of the combustion-chamber cylinder head. A portion of the body 105 proximate the insulator tip 115 functions as a ground electrode 125. Unlike in conventional spark plugs featuring a hook-shaped ground electrode, ground electrode 125 is annularly disposed around the entire circumference of insulator tip 115 and thus sparks are not confined to travel along a single specific path to the ground electrode 125.

The insulator 110 typically includes or consists essentially of a dielectric material such as a ceramic, and serves to electrically and mechanically isolate the body 105 from the center electrode 130 housed within the insulator 110. The insulator 110 also houses a terminal 135 that electrically connects to the ignition system that controls the timing of the firing of the spark plug 100 by cyclic application of high voltage to the terminal 135. The insulator 110 may also feature one or more ribs 140, to increase the electrical resistance between center electrode 130 and body 105 by disrupting and lengthening the potential electrical path therebetween. In preferred embodiments of the invention, the insulator 110 is a single, unified part, rather than, e.g., multiple parts adhered or mechanically fit together, and thus has superior mechanical properties and resistance to wear and fracture. The dimensions of the insulator 110 are generally determined by its intended use, e.g., the dimensions of the combustion chamber or engine to which the spark plug 100 is to be coupled. In an embodiment, a longitudinal length of the insulator 110 is between approximately 50 mm and approximately 80 mm, e.g., between approximately 58 mm and approximately 62 mm. The diameter of insulator tip 115 may be between approximately 4 mm and approximately 10 mm, e.g., between approximately 6 mm and approximately 7 mm.

The sparks emitted by spark plug 100 during operation originate from a tip 145 of the center electrode 130 that protrudes from the insulator tip 115. The sparks travel along any spark path also defined by the placement of the ground electrode 125 and any auxiliary electrodes disposed between the center electrode tip 145 and the ground electrode 125 (as described in more detail below). The center electrode 130 typically includes or consists essentially of a highly conductive material such as a metal or a metal alloy, e.g., copper, chromium, yttrium, iridium, platinum, tungsten, palladium, silver, gold, nickel-iron alloys, and/or alloys or mixtures of any of these. In some embodiments, the center electrode 130 has a core of one conductive material, e.g., copper, surrounded by a shell of another, in order to improve thermal dissipation therefrom. The center electrode 130 is typically connected to a terminal 135 by an internal electrical connection, e.g., a wire, and a series resistance (e.g., a ceramic insulator material such as calcium carbonate phosphate) that reduces radio-frequency noise during operation of the spark plug 100. The diameter of the center electrode 130 (and/or the center electrode tip 145) may be between approximately 2 mm and approximately 5 mm, e.g., approximately 3 mm.

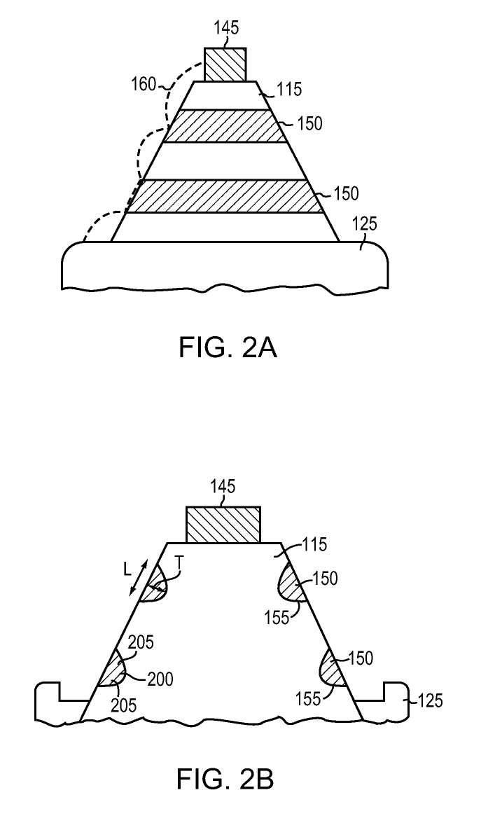

One or more auxiliary electrodes 150 are disposed along the insulator tip 115 between the center electrode tip 145 and the ground electrode 125. Preferred embodiments of the invention feature two auxiliary electrodes 150, as shown in FIGS. 1, 2A, and 2B, but a single auxiliary electrode or more than two auxiliary electrodes 150 may be utilized, depending on the desired spark path and the geometry of the insulator tip 115. For example, the longitudinal length of the insulator tip 115 protruding from the body 105 may limit the number of auxiliary electrodes 150 that may be formed between the center electrode tip 145 and the ground electrode 125.

Referring also to FIGS. 2A and 2B, each auxiliary electrode 150 is preferably disposed within a substantially annular groove 155 formed by the insulator tip 115. During operation of the spark plug 100, sparks form between the center electrode tip 145 and the ground electrode 125, effectively “traveling” or “jumping” from the center electrode tip 145 to the auxiliary electrode(s) 150 to the ground electrode 125, thus defining a spark path 160. Effectively, multiple sparks, each one formed in one of these “jumps” are formed during each ignition cycle. And, being composed of multiple smaller spark gaps, the spark path 160 may be longer in extent than the spark gap required by conventional spark plugs with hook-shaped ground electrodes. This longer spark path 160 increases the probability of proper ignition within the combustion chamber during each ignition cycle.

In preferred embodiments, grooves 155 are generally circumferentially disposed around a conical contour of (rather than, e.g., concentrically along a generally planar end face of) the insulator tip 115 in order to facilitate definition of a spark path 160 having a greater longitudinal extent within the combustion chamber. Such a spark path 160 may advantageously enable more predictable and complete ignition of the fuel-air mixture inside the combustion chamber, even when the mixture is lean (i.e., air-rich). Furthermore, rather than being confined or localized to a particular position along the circumference of the insulator tip 115, the spark path 160 may form at any point along that circumference, due to the generally annular symmetrical shape of the auxiliary electrodes 150 and the ground electrode 125. This delocalization of the spark path 160 also facilitates ignition during operation of the spark plug 100.

Auxiliary electrodes 150 generally include or consist essentially of an electrically conductive material, e.g., a metal or a metal alloy. Due to their limited physical size (compared to, e.g., the center electrode 130), the auxiliary electrodes 150 preferably include or consist essentially of a metal or metal alloy having significant mechanical toughness and resistance to cracking and/or a coefficient of thermal expansion similar to that of the insulator tip 115, to ensure reliable, long life during the high-temperature cyclic operation of the spark plug 100. Furthermore, auxiliary electrodes 150 preferably have a high melting point, e.g., between approximately 1400° C. and approximately 1500° C. (for example, approximately 1455° C.), for stability during such high-temperature operation.

Auxiliary electrodes 150 preferably include or consist essentially of a nickel-based alloy. The nickel-based alloy may also include, e.g., aluminum, chromium, iron, niobium, tantalum, molybdenum, boron, and/or titanium in any of a variety of combinations and compositions. For example, auxiliary electrodes 150 include or consist essentially of an alloy of nickel and aluminum, e.g., an alloy including between approximately 15% and approximately 40% aluminum such as Ni₇₀Al₃₀ or Ni₈₀Al₂₀. In other embodiments, auxiliary electrodes 150 include or consist essentially of an alloy of nickel and chromium, e.g., one including between approximately 15% and approximately 30% chromium such as Ni₈₀Cr₂₀. Still other embodiments feature auxiliary electrodes 150 including or consisting essentially of NiCrFeNbTaMoTi and/or NiCrFeCoTaMoBTi alloys, e.g., Ni_{53.8}Cr₁₉Fe₁₈(NbTa)_{5.1}Mo₃₁Ti₁ and/or Ni_{51.5}Cr₁₉Fe₁₈(CoTa)₅Mo₃B_{2.5}Ti₁. In some embodiments, different auxiliary electrodes 150 may include or consist essentially of different materials and/or alloy compositions. In other embodiments, each auxiliary electrode 150 includes or consists essentially of the same material and alloy composition.

Each groove 155 preferably has a smooth internal contour (e.g., free of sharp corners) and defines a substantially semicircular or substantially triangular cross-sectional shape (e.g., having a rounded rather than a sharp vertex), and may be formed by, e.g., material removal (for example by turning, grinding, etc.) from the insulator 110. Alternatively, the insulator 110 may be initially shaped to contain grooves 155 via, e.g., forming and sintering techniques known to practitioners of the ceramic arts. While auxiliary electrodes 150 may be formed after assembly of the insulator 110 with the body 105, typically they are formed on the insulator tip 115 prior to insertion of the insulator 110 within the body 105. Although auxiliary electrodes 150 may be formed by, e.g., insertion and bonding or adhering of discrete, pre-shaped parts, auxiliary electrodes 150 are preferably formed by a spray-deposition process, e.g., a thermal-spray process such as Rokide rod spraying. During spray deposition of auxiliary electrodes 150, the auxiliary-electrode material (typically in powder, wire, or liquid form) is heated and accelerated toward each groove 155 by a thermal-spray apparatus known to those skilled in the art. The starting material, in molten, semi-molten, or thermally softened form, contacts, solidifies, and adheres to the surface of the groove 155. Further introduction of the starting material thickens the auxiliary electrode 150 until it substantially fills the groove 155. The insulator 110 is preferably rotated during deposition of the auxiliary electrodes 150, in order to facilitate even filling of each groove 155. Auxiliary electrodes 150 thus fabricated have superior mechanical strength and resistance to wear, breakage, and dislodgement compared to electrodes formed by other methods such as bonding. Furthermore, the spray-deposition process facilitates the fabrication of auxiliary electrodes 150 having a variety of cross-sectional shapes and sizes, although certain shapes are preferred in most embodiments, as detailed below. Moreover, spray deposition enables the fabrication of auxiliary electrodes 150 that are each substantially seamless and gap-free along their circumference—such configurations are advantageous, because seams or breaks in the auxiliary electrode may result in inconsistent performance properties or stress concentration at such points, decreasing the reliability and lifetime of the spark plug 100. The spray-deposition process is typically a bulk deposition process that builds up each auxiliary electrode 150 more rapidly than processes that deposit layer-by-layer of atomic or molecular thickness, e.g., vapor deposition, thus enabling more economical fabrication of the auxiliary electrodes 150 and the spark plug 100. In various embodiments, the spray-deposition process and equipment does not involve generation or utilization of a plasma and its concomitant complexity or extreme temperatures.

As utilized herein, an auxiliary electrode 150 substantially filling a groove 155 conforms to the contour of the groove 155 and fills the groove 155, without introduction of voids or significant porosity, at least to the surface defined by the external contour of the insulator tip 115 outside of the grooves 155. In various embodiments, the auxiliary electrode 150 does not protrude from the groove 155 along its surface, as such protrusions may be stress concentrators or may result in preferential spark formation along such points, unless desired. After completion of the spray-deposition process, each auxiliary electrode 150 may substantially fill a groove 155, such that the exposed surfaces of the auxiliary electrode 150 and insulator tip 115 form, e.g., a cylinder or a truncated cone having a substantially contiguous external contour. Preferably the spray-deposition process is controlled so as to facilitate the substantial filling of each groove 155 without the need for mechanical grinding or finishing of auxiliary electrodes 150 after deposition to form the above-described substantially contiguous contour. In some embodiments, the external contour may be polished with, e.g., a diamond paper or cloth, to dress the surface thereof and/or to remove minor protrusions.

Preferred shapes and orientations of each groove 155 (and thus, of the auxiliary electrode 150 formed therein) facilitate the efficient and complete filling thereof by spray deposition to form the auxiliary electrodes 150. As shown in FIG. 2B, each auxiliary electrode 150 preferably has a center portion 200 having a thickness greater than that of an edge portion 205. Such a geometry imbues auxiliary electrode 150 with superior mechanical strength and reliability than if, e.g., edge portions 205 had greater thicknesses than that of the center portion 200. Further, any wear of an edge portion 205 during operation of the spark plug 100 results in exposure of regions of the auxiliary electrode 150 having increasingly larger thickness and, thus, further wear of the electrode is self-limiting. Moreover, any edge portions 205 thicker than a center portion 200 (and/or any discontinuities and/or corners in the contour of the groove 155 associated therewith) may render substantial filling of the groove 155 by spray deposition more difficult (as further detailed below). A longitudinal length L of each auxiliary electrode 150 is also preferably equal to or greater than a radial thickness T (i.e., the cross-sectional point of greatest extent into insulator tip 115) of the auxiliary electrode 150. Such dimensions, particularly when coupled with a smooth contour of the groove 155, facilitate the substantial filling of the groove 155 via spray deposition. In contrast, grooves in which T were greater than L can be much more difficult to fill with the auxiliary-electrode material due to, e.g., shadowing effects. Specifically, since the spray-deposition process may be substantially directional, the electrode material may be blocked from reaching the inner contour(s) of groove 155 by its outer edges, thereby resulting in potentially deleterious void formation.

In an exemplary embodiment, the longitudinal exposed length L of one or more auxiliary electrodes 150 is in a range between approximately 0.8 mm and approximately 2 mm, e.g., between approximately 1.1 mm and approximately 1.6 mm. In some embodiments, the longitudinal length L of different auxiliary electrodes 150 may be different, e.g., L may be smaller for an auxiliary electrode 150 disposed toward the ground electrode 125 than that of an auxiliary electrode 150 disposed toward the center electrode tip 145. Furthermore, a spacing between auxiliary electrodes 150 may be equal to or less than a longitudinal length L of any of the auxiliary electrodes 150, e.g., between approximately 0.2 mm and approximately 0.8 mm, for example, approximately 0.4 mm. The spacing along the insulator tip 115 between the center electrode tip 145 and the closest auxiliary electrode 150 thereto may be between approximately 0.5 mm and approximately 1 mm, e.g., approximately 0.8 mm. The radial thickness T of each auxiliary electrode 150 may be equal to or less than approximately 0.8 mm.

Additionally, each auxiliary electrode 150 preferably has a substantially uniformly symmetric cross-section, i.e., a center point of each groove 155 is its point of deepest extent within the insulator tip 115, and the auxiliary electrode 150 is generally symmetric thereabout. (That is, the auxiliary electrode 150 is not oriented within the insulator tip 115 at a “tilt” toward either longitudinal end of insulator 110 other than that which may be inherent due to the conical surface contour of the insulator tip 115 and, accordingly, the exposed surfaces of the auxiliary electrodes 150.) Such an orientation may result in substantially uniform wear (i.e., end-to-end) of the auxiliary electrode 150, if such wear occurs, during operation of the spark plug 100.

### EXAMPLES

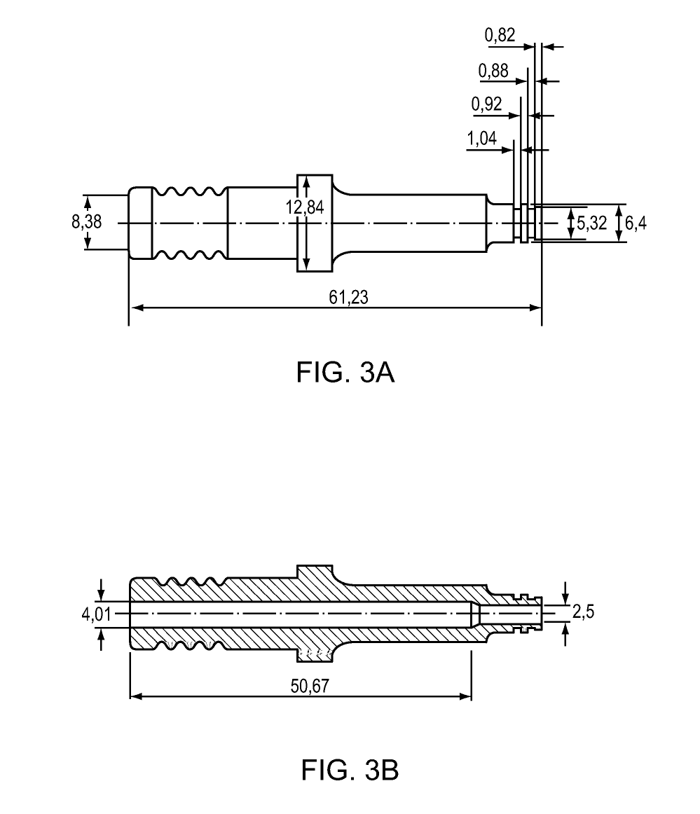

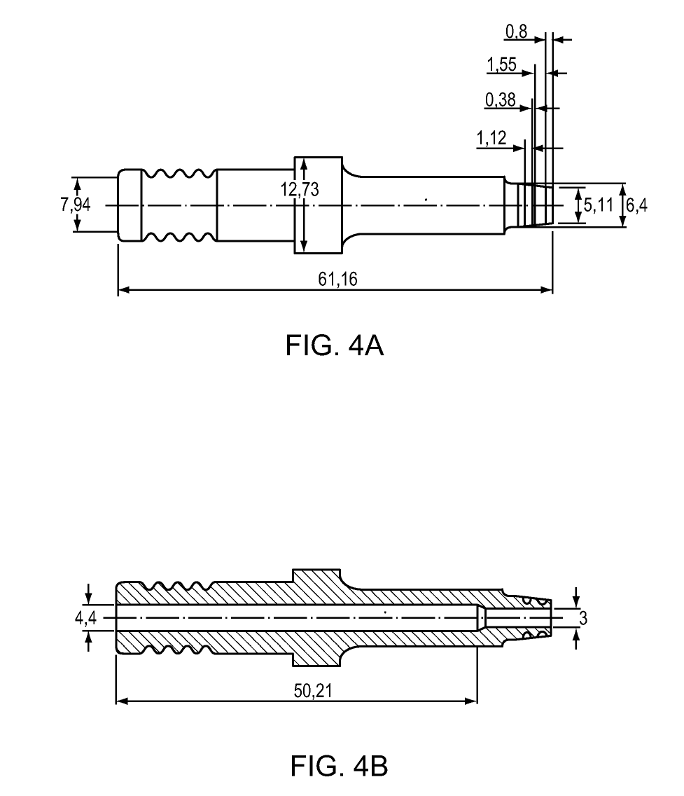

FIGS. 3A, 3B, 4A, and 4B depict various views of spark plug insulators in accordance with certain embodiments of the invention. These figures are presented merely in order to indicate exemplary dimensions (indicated on the figures in millimeters), rather than to indicate, e.g., specific contours or shapes of the auxiliary electrode grooves 155.

The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A spark plug comprising:
an electrically conductive body disposed around an insulator, a tip of the insulator protruding from the body;
a generally radially disposed annular groove formed by the insulator tip;
a center electrode disposed within the insulator, a tip of the center electrode protruding from the insulator tip; and
an annular auxiliary electrode disposed within the annular groove, the auxiliary electrode having a center portion thicker than an edge portion thereof,
wherein a longitudinal length of the auxiliary electrode is greater than a radial thickness of the auxiliary electrode.

2. The spark plug of claim 1, wherein the auxiliary electrode does not protrude from the groove.

3. The spark plug of claim 1, wherein a cross-sectional shape of the auxiliary electrode is selected from the group consisting of a substantially semicircular shape and a substantially triangular shape.

4. The spark plug of claim 1, wherein the auxiliary electrode substantially fills the annular groove.

5. The spark plug of claim 1, wherein exposed surfaces of the auxiliary electrode and the insulator tip form a truncated cone having a substantially contiguous contour.

6. The spark plug of claim 1, wherein the auxiliary electrode comprises a nickel-based alloy.

7. The spark plug of claim 6, wherein the nickel-based alloy is selected from the group consisting of a NiAl alloy, a NiCr alloy, a NiCrFeNbTaMoTi alloy, a NiCrFeCoTaMoBTi alloy, and mixtures thereof.

8. The spark plug of claim 1, wherein a melting point of the auxiliary electrode is in a range between approximately 1400° C. and 1500° C.

9. The spark plug of claim 1, further comprising:
at least one additional annular groove spaced apart from the annular groove and formed by the insulator tip; and
an additional auxiliary electrode disposed within each additional annular groove.

10. The spark plug of claim 1, wherein the auxiliary electrode is substantially seamless.

11. A method of forming a spark plug, the method comprising:
providing an insulator having an annular groove formed by a tip thereof;
spray depositing an auxiliary electrode material within the groove, thereby forming an annular auxiliary electrode disposed within the groove;
disposing a center electrode within the insulator such that a tip of the center electrode protrudes from the insulator tip; and
disposing at least a portion of the insulator within an electrically conductive body.

12. The method of claim 11, wherein the auxiliary electrode material is deposited by a thermal spray process.

13. The method of claim 11, wherein, prior to deposition, the auxiliary electrode material is in a form selected from the group consisting of powder and wire, the auxiliary electrode material substantially melting during deposition.

14. The method of claim 11, wherein the insulator is rotated during deposition of the auxiliary electrode material.

15. The method of claim 11, wherein neither the insulator tip nor the auxiliary electrode are mechanically ground after deposition of the auxiliary electrode material.

16. The method of claim 15, wherein an exposed surface of the auxiliary electrode and an exposed surface of the insulator are substantially contiguous.

17. The method of claim 11, wherein the auxiliary electrode material comprises a nickel-based alloy.

18. The method of claim 17, wherein the nickel-based alloy is selected from the group consisting of a NiAl alloy, a NiCr alloy, a NiCrFeNbTaMoTi alloy, a NiCrFeCoTaMoBTi alloy, and mixtures thereof.

19. The method of claim 11, wherein a center portion of the auxiliary electrode is thicker than an edge portion of the auxiliary electrode.

20. The method of claim 11, wherein a longitudinal length of the auxiliary electrode is greater than a radial thickness of the auxiliary electrode.

21. The method of claim 11, wherein the auxiliary electrode substantially fills the groove.

22. The method of claim 11, wherein at least one additional annular groove is formed by the tip of the insulator and spaced apart from the annular groove, further comprising spray depositing the auxiliary electrode material within the at least one additional groove, thereby forming at least one additional annular auxiliary electrode disposed within the at least one additional groove.

23. A spark plug comprising:
an electrically conductive body disposed around an insulator, a tip of the insulator protruding from the body;
a center electrode disposed within the insulator, a tip of the center electrode protruding from the insulator tip; and
an auxiliary electrode disposed along the insulator tip and spaced apart from the center electrode tip and the body, the auxiliary electrode comprising a nickel-based alloy.

24. The spark plug of claim 23, wherein the auxiliary electrode is substantially annular.

25. The spark plug of claim 24, wherein the auxiliary electrode is disposed within and substantially fills an annular groove formed by the insulator tip.

26. The spark plug of claim 25, wherein a center portion of the auxiliary electrode is thicker than an edge portion of the auxiliary electrode.

27. The spark plug of claim 25, wherein a longitudinal length of the auxiliary electrode is greater than a radial thickness of the auxiliary electrode.

28. The spark plug of claim 23, wherein the nickel-based alloy is selected from the group consisting of a NiAl alloy, a NiCr alloy, a NiCrFeNbTaMoTi alloy, a NiCrFeCoTaMoBTi alloy, and mixtures thereof.

29. The spark plug of claim 23, further comprising at least one additional auxiliary electrode disposed along the insulator tip and spaced apart from the center electrode tip and the auxiliary electrode.

30. The spark plug of claim 29, wherein the at least one additional auxiliary electrode comprises the nickel-based alloy.
